(19) United States
(12) Patent Application Publication
(10) Pub. No.: US 2006/0042958 A1
(43) Pub. Date: Mar. 2, 2006

(54) Device and method for treating water and removing contaminants from soil

(76) Inventor: Frank Cole, Fort Myers, FL (US)

Correspondence Address: HAHN LOESER & PARKS, LLP, One GOJO Plaza, Suite 300, AKRON, OH, 44311-1076, US

(21) Appl. No.: 10/926,176

(22) Filed: Aug. 25, 2004

(51) Int. Cl. C02F 1/461

(52) U.S. Cl. 205/745

(57) ABSTRACT

Novel water ionization devices are described and claimed. The inventive device comprises an outer tube formed of or having an inner metal liner, a second tube formed of metal and housed within the outer tube, and an innermost tube formed of metal and housed within the second tube. The second and innermost tubes include a plurality of holes drilled through their respective walls. The device has an water inlet end whereby water is forced, under pressure, into the device. As the water enters the innermost tube, it is forced out through the holes of the innermost and second tubes and against the metal walls of all three tubes, to cause chemical reactions to occur that dissociates the water molecules, thereby causing an increase concentration of hydroxyl ions. The ionized water is an excellent oxidizers for use in removing hydrocarbon contaminants from soil, for example.

### SUMMARY OF THE INVENTION:

The present invention is directed to a device and method for more effectively ionizing water. The ionized water, being rich in hydroxyl ions, may be used to remove hydrocarbon contaminants from soil. The ionized water may also be used in irrigation of agricultural soil.

Specifically, the inventive device comprises a first tube having an inner chamber and an inner wall surface lined with or formed of a metal. This metal may include aluminum, aluminum alloys, and the like. The device further includes a second tube co-axially aligned and contained within the first tube. The second tube further has a wall and a plurality of holes penetrating through the wall. This second tube is formed of a metal which may be selected from the group of copper, copper alloys, and the like. The device also includes a third tube co-axially aligned and contained within the second tube, the third tube having a smaller diameter than the second tube. The third tube also has a wall and a plurality of holes penetrating the wall. Like the second tube, the third tube is formed of a metal which may be selected from copper, copper alloys, and the like. The first tube has a water intake end and a water outlet end through which water entering the device may flow. The innermost third tube also has a water intake end aligned with the water intake end of the first tube, the third tube having a second end superjacent the water outlet end of the first tube, such that as water is forced, under pressure, through the water intake end, the water first enters the inner chamber of the third tube directly via the water intake end of the third tube and exits the third tube into the inner chamber of the second chamber via the plurality of holes of the third tube.

Preferably, the device includes at least one porous metal pad disposed within the inner chamber of the first tube between the second end of the third tube and the water outlet end of the first tube. Exemplary metals that may be used to fabricate the pads include but are not limited to, stainless steel, copper, nickel, and the like. One single pad extending from the water outlet end of the device and an end of the second tube may be employed or a plurality of single pads may be employed. Preferably, the device comprises one or more pads, more preferably four pads, formed of one metal type (e.g. stainless steel) and one or more pads, preferably four pads, of a second, different metal type (e.g. copper).

### BRIEF DESCRIPTION OF THE FIGURES:

FIG. 1 is a schematic side view, partially sectioned, of the inventive device (i.e. “Hydrogen Accelerator”).

FIG. 2 is side view, partially sectioned, of the three separate tubes comprising the Hydrogen Accelerator illustrated in FIG. 1.

FIG. 3 is a transverse cross-sectional view taken along lines 3-3 of FIG. 1.

FIG. 4 is a perspective view of the second tube and metal pads alone, including the cap and nozzle port.

FIG. 5 is a perspective view of the first tube, including the caps and nozzle ports.

FIG. 6 is cross section of the outer tube, taken along lines 6-6 of FIG. 5.

FIG. 7 is a cross section of the outer tube, taken along lines 7-7 of FIG. 5.

FIG. 8 is a schematic flow chart illustrating the incorporation of the inventive Hydrogen Accelerator in a process for removing contaminants from soil.

### DETAILED DESCRIPTION OF THE PREFERRED EMBODIMENTS:

The present invention is directed to a device for ionizing water via cavitation chemistry. The ionized water is rich in hydroxyl ions, which are effective oxidizers for use in many applications. One application for the treated water is to remove hydrocarbon contaminants (e.g. petroleum) from soil. Another application for the ionized water is for use in irrigation to enhance the plant's ability to absorb nutrients from the soil and fertilizer as well as to breakdown certain salts, either existing already in the soil or introduced by fertilizer, that can cause poisoning in plants. Other applications of the ionized water are disclosed in U.S. Pat. No. 6,106,787, for example.

Referring now to the figures, the present invention is directed to an improved water ionizing device, which the inventor herein has named the Hydrogen Accelerator™ 10. The Hydrogen Accelerator comprises a combination of three co-axially aligned tubes. The first tube 11 is an outermost hollow tube, preferably formed of a durable plastic material, such as PVC piping. Other materials for fabricating the outer tube 11 may be employed, including, but not limited to, aluminum and aluminum alloys. This first tube 11 comprises an inner wall surface 12 that is either lined with, or formed of, a metal. Preferable metals include, but are not limited to, aluminum and aluminum alloys. Alternatively, the entire tube 11 may be formed of metal, such as aluminum. A second tube 13 is co-axially aligned and contained within the inner chamber 20 of the outer tube 11. This second tube has a smaller inner diameter D² than the inner diameter D¹ of the outer first tube 11. For example, if the diameter D¹ of the outer first tube 11 is 4 inches, the inner diameter D² of the second tube 13 is preferably about 1.5 inches. This second tube 13 is also preferably shorter in length than the outer tube 11. The second tube includes a plurality of holes 30 penetrating through the walls of the tube to communicate with the inner chamber 21 of the second tube. In a preferred embodiment, twenty-five holes 30, each having a bore diameter of about 1/16 inch, are provided. The holes 30 may be randomly positioned about the tube. The second tube 12 is formed of a metal, preferably copper, although other metals may be employed.

A third, innermost, tube 14 is also provided, this third tube 14 being co-axially aligned and contained within the inner chamber 21 of the second tube 13. The inner diameter D³, and preferably the length L³, of this third tube 14 are smaller than the inner diameter D² and length L² of the second tube. For example, if the second tube has an inner diameter D² of 1.5 inches as discussed above, the preferable inner diameter D³ for the third tube 14 is about 0.5 inches. Like the second tube, the third tube also contains a plurality of holes 31 randomly drilled through its outer walls. In a preferred embodiment, twenty-five holes, each having a bore diameter of 1/16 inch, are provided. The holes 31 may be randomly positioned throughout the outer walls of the tube 14. The third tube is also formed of a metal, preferably copper, although other metals may be employed.

It will be appreciated by the skilled artisan that the size and number of holes 30, 31 drilled through the second and third tubes may vary, depending upon the water pressure available and the desired flow rate. For example, the number and size of the holes described herein with respect to the preferred embodiment reflect the optimal hole number and hole size for producing the desired flow rate of 10 gallons per minute using a pump operating at a pressure of 60 psi, as discussed in more detail below.

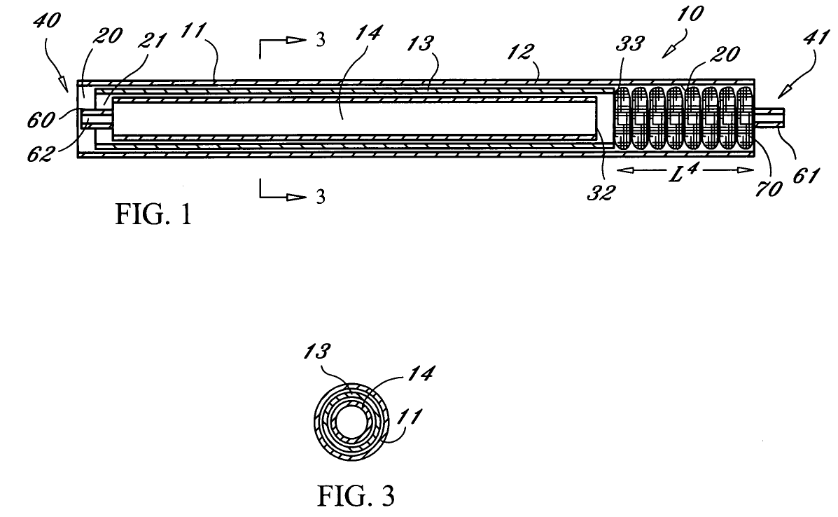

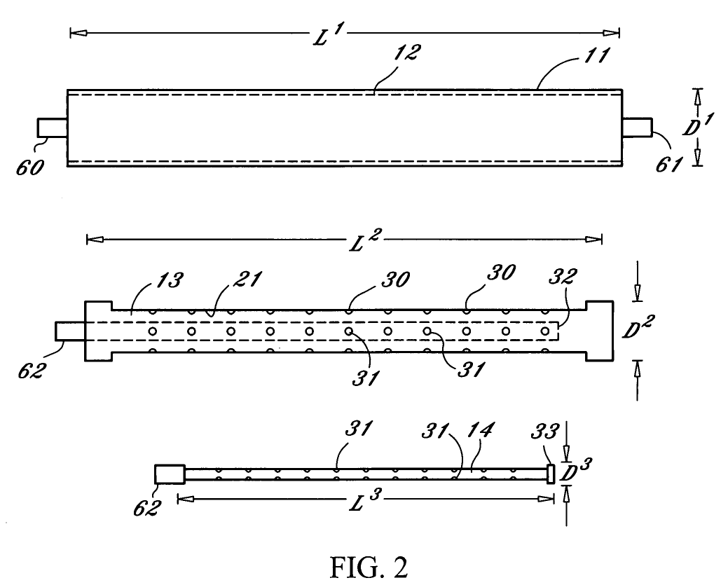

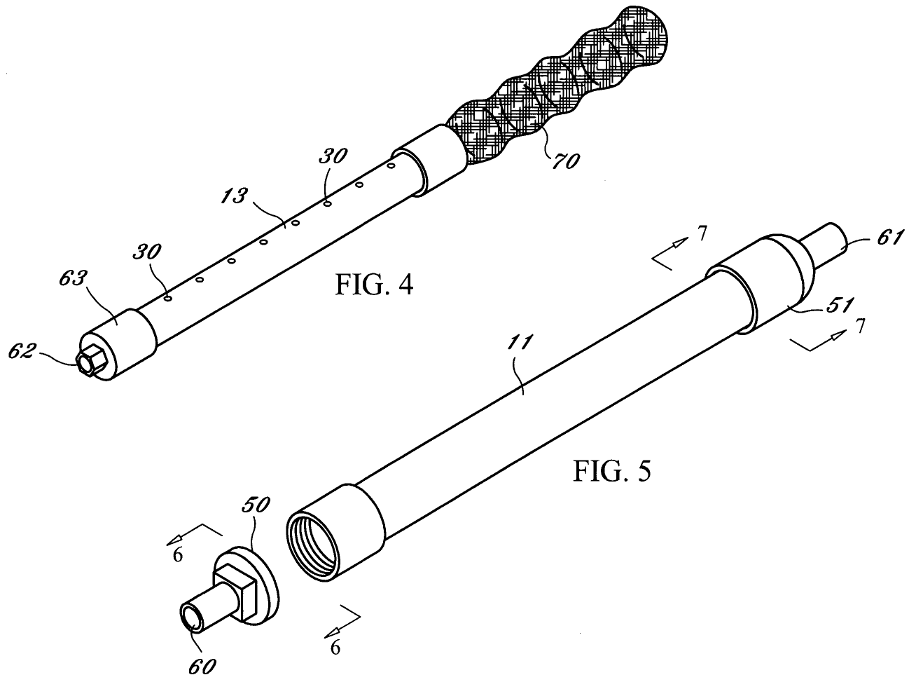

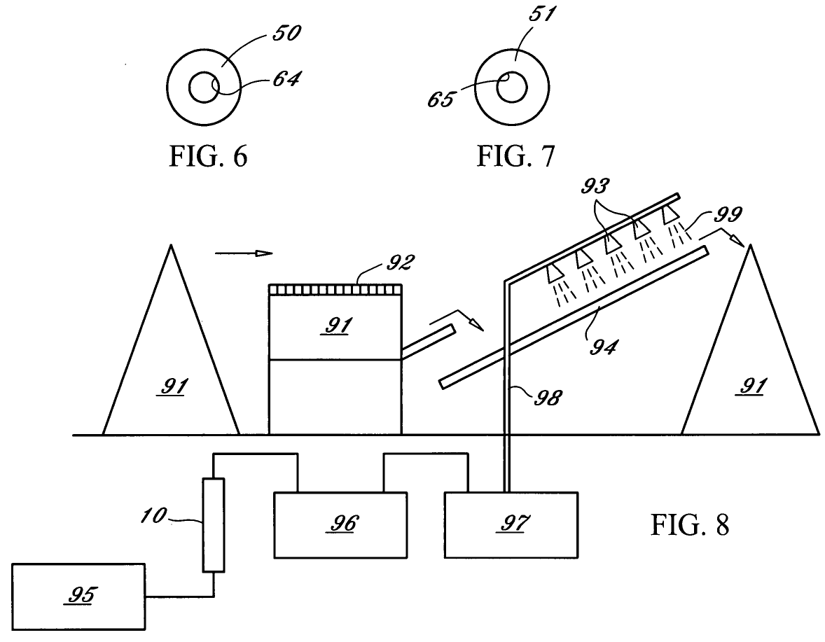

The outer first tube 11 of the Hydrogen Accelerator 10 includes a water intake end 40 and a water outlet end 41, each of which may be capped 50, 51, as best illustrated in FIG. 5. Each of the second and third tubes have terminal ends 32, 33 nearest the water outlet end 41 (see FIGS. 1-2, for example). These terminal ends 32, 33 are preferably closed entirely, as shown. Optionally, one or both of the terminal ends 32,33 may have one or more holes (not shown) penetrating therethrough. The third tube 14 has a corresponding water intake end 62 that may be configured, as shown, to engage the cap 50 of the outer tube 11. The cap 50, in turn, includes an opening 64 in communication with a hose connection 60 through which water may enter via a hose, for example, the hose connection 60 and opening being registration with the water intake end 62 of the third tube (FIGS. 5-6). As shown in FIG. 4, the water intake end of third tube 14 extends through the capped end 63 of the second tube 13, such that water entering the Hydrogen Accelerator through the hose connection 60 is first forced directly into the third tube 14. The water outlet end 41 of the outer tube is capped 51, but also includes an opening 65 in communication with a hose connector 61 (FIGS. 5 and 7).

Positioned within the inner chamber 20 of the outer tube 11 are a series of one or more metal pads 70, each of the pads preferably having a diameter similar to the inner diameter of the outer tube. The pads are positioned between the terminal end 33 of the second tube 13 and the water outlet end 41 of the outer first tube 11. For a Hydrogen Accelerator 10 comprising a 48-inch long outer tube housing a 36-inch long second tube, for example, a plurality of pads (or a single pad) having a combined length L⁴ of about 12 inches is employed. It will be appreciated by the skilled artisan, however, that the length of the total metal padding may be increased or decreased, depending upon the dimensions of the Hydrogen Accelerator tubes. The pads may be formed of a metal or metal alloy, preferably including, but not limited to, stainless steel, copper and copper alloys, nickel, and the like. Preferably, two sets of pads (or two large, single pads) formed of different metals, are employed in the present invention. For example, a set of copper pads and a set of stainless steel pads may be used.

In operation, water is pumped, under pressure, into the Hydrogen Accelerator through the water intake end. For a Hydrogen Accelerator having a 48-inch long outer tube, 36-inch long second tube, and 34-inch long third tube, the second and third tubes each having twenty-five randomly drilled 1/16-inch holes, typical pressures range from about 50 to about 70 psi, preferably about 60 psi, for a flow rate of about 10 gallons per minute. It will be appreciated by those of ordinary skill in the art that if greater volumes of water are needed for treatment, the pressure may be increased, the dimensions of the Hydrogen Accelerator could be increased, and/or an additional Hydrogen Accelerator could be employed.

As water is pumped through the Hydrogen Accelerator, the water is forced through a water intake opening 60 in the third tube 14 and subsequently through the holes 31 drilled through the walls of the third tube. The water then comes into contact with the inner walls of the second tube and is forced out of the holes 30 contained within the second tube 13. The water exits these second holes 30, contacts the metal liner or inner surface 12 of the outer tube and is then forced through the metal pad(s) housed within the inner chamber 20 of the outer tube 11 as the water exists through the water outlet end 41.

As the water is forced through Hydrogen Accelerator under pressure, the water impinges against the metal walls of the second and third metal tubes, the inner metal lining 12 of the outer tube, and the series of metal pads. It is believed that this impingement against these various metal surfaces of the Hydrogen Accelerator produce cavitation to causes chemical reactions to occur between the water molecules and the metals of the Hydrogen Accelerator, thereby causing a disassociation of water molecules (i.e. ionization). The resulting ionized water is rich in hydroxyl ions, which are excellent oxidizers for use in removing hydrocarbon contaminants from soil and for use in irrigating agricultural soil. It is believed that the employment of the two inner metal tubes, each containing the randomly drilled holes, housed within the metal-lined outer first tube, provides an increased agitation of the water for more effective cavitation. This agitation is further increased by the provision of the metal pads within the outer tube, which the water finally contacts before exiting the Hydrogen Accelerator through the water outlet end 41.

As discussed above, the resulting ionized water that has been processed by the inventive Hydrogen Accelerator may be used to treat contaminated soil, in particular soil containing unacceptably high amounts of petroleum hydrocarbons. A exemplary method for treating such contaminated soil is shown schematically in FIG. 8, wherein a conveyor 94 of soil 91 is passed by nozzles 93 in communication with a tank 96 containing the ionized water prepared by the inventive Hydrogen Accelerator 10 as well as a tank 97 containing a second oxidizer, the nozzles further connected to the tanks via a hose 98, for example. Prior to treatment with the ionized water and oxidizer, the soil is passed through a screen 92 to remove rocks and other large particles or debris. As the soil is passed by these nozzles 93, the ionized water and second oxidizer are sprayed 99 simultaneously onto the soil 91. Exemplary oxidizers include, but are not limited to, hydrogen peroxide and potassium permanganate. For soils with high clay content, lime may also be added.

When hydrogen peroxide is used in the foregoing soil treatment process, the hydrogen peroxide is produced by mixing sodium percarbonate (2NaCO_{3.}3H₂O₂) and an acidic activator, such as soda ash or lime. As a rule of thumb, about 50 pounds of sodium percarbanate is used per 400 tons of soil per 5000 parts per million of contamination. The sodium carbanate/soda ash (or lime) mixture are applied to the soil dry at a rate of about 1 pound per 400 tons of soil. If potassium permanganate is used as the second oxidizer, about 10 pounds of the potassium permanganate (KMNO₄) is applied to every 800 tons of soil processed

Preferred dimensions (e.g. length and diameter of the tubes) of the inventive device have been disclosed herein; however, it will be recognized by those of ordinary skill in the art, having the benefit of the teachings of this disclosure and the prior art, that such dimensions may be modified. Such modifications may be desired to accommodate the treatment of larger volumes (or smaller volumes) of water over a shorter or longer time period, for example.

1. A device for ionizing water, said device comprising:
a. a first tube having an inner chamber and an inner wall surface lined with or formed of a metal or metal alloy;
b. a second tube co-axially aligned and contained within said inner chamber of said first tube, said second tube further having an inner chamber, a wall, and a plurality of holes penetrating through said wall, said second tube formed of a metal or metal alloy;
c. a third tube co-axially aligned and contained within said second tube, said third tube further having an inner chamber, a wall, and a plurality of holes penetrating said third tube wall, said third tube formed of a metal or metal alloy;
d. said first tube having a water intake end and a water outlet end through which water entering said device may flow; and
e. said third tube having a water intake end aligned with said water intake end of said first tube, such that as water is forced, under pressure, through said water intake end, said water first enters said inner chamber of said third tube directly via said water intake end of said third tube and exits said third tube into said inner chamber of said second chamber via said plurality of holes of said third tube.

2. The device of 1, wherein said first tube metal is selected from the group of aluminum and aluminum alloys.

3. The device of claim 1, wherein said second tube metal and said third tube metal is selected from the group of copper and copper alloys.

4. The device of claim 3, wherein said first tube metal is selected from the group of aluminum, aluminum alloys.

5. The device of claim 1, wherein said second tube metal and said third tube metal are identical.

6. The device of claim 1, further including at least one porous first metal pad disposed within said first tube inner chamber between said second end of said second tube and said water outlet end of said first tube.

7. The device of claim 6, wherein said at least one first metal pad is formed of a metal selected from copper, copper alloys, stainless steel, and nickel.

8. The device of claim 6, further including at least one porous second metal pad disposed within said inner chamber between said at least one first pad and said water outlet end of said first tube.

9. The device of claim 8, wherein said at least one second metal pad is formed of a metal selected from copper, copper alloys, stainless steel, and nickel.

10. A device for ionizing water, said device comprising:
a. a first tube having an inner chamber and an inner wall surface lined with or formed of a metal selected from the group of aluminum and aluminum alloys;
b. a second tube co-axially aligned and contained within said inner chamber of said first tube, said second tube further having an inner chamber, a wall, and a plurality of holes penetrating through said wall, said second tube formed of a metal selected from the group of copper, copper alloys; and
c. a third tube co-axially aligned and contained within said second tube, said third tube further having an inner chamber, a wall, and a plurality of holes penetrating said third tube wall, said third tube formed of a metal selected from the group of copper and copper alloys;
d. said first tube having a water intake end and a water outlet end through which water entering said device may flow; and
e. said third tube having a water intake end aligned with said water intake end of said first tube, said third tube having a second end superjacent said water outlet end of said first tube.

11. The device of claim 10, further including at least one porous first metal pad disposed within said first tube inner chamber between said second end of said second tube and said water outlet end of said first tube.

12. The device of claim 11, wherein said at least one first metal pad is formed of a metal selected from copper, copper alloys, stainless steel, and nickel.

13. The device of claim 12, further including at least one porous second metal pad disposed within said first tube inner chamber between said at least one first pad and said water outlet end of said first tube.

14. The device of claim 13, wherein said at least one second metal pad is formed of a metal selected from copper, copper alloys, stainless steel, and nickel.

15. The device of claim 10, wherein said second tube metal and said third tube metal are identical.

16. The device of claim 15, wherein said second tube metal and said third tube metal are both copper.

17. The device of claim 16, wherein said first tube metal is aluminum.

18. A device for ionizing water, said device comprising:
a. a first tube having an inner chamber and an inner wall surface lined with or formed of a metal selected from the group of aluminum and aluminum alloys;
b. a second tube co-axially aligned and contained within said inner chamber of said first tube, said second tube further having a wall and a plurality of holes penetrating through said wall, said second tube formed of a metal selected from the group of copper and copper alloys;
c. a third tube co-axially aligned and contained within said second tube, said third tube further having an inner chamber, a wall, and a plurality of holes penetrating said third tube wall, said third tube formed of a metal selected from the group of copper and copper alloys;
d. said first tube having a water intake end and a water outlet end through which water entering said device may flow;
e. said third tube having a water intake end aligned with said water intake end of said first tube, said third tube having a second end superjacent said water outlet end of said first tube; and
f. at least one porous metal pad disposed within said inner chamber between said second end of said second tube and said water outlet end of said first tube.

19. The device of claim 18, wherein said pad metal selected from copper, copper alloys, stainless steel, and nickel.

20. The device of claim 19, including at least two of said metal pads, wherein one of said pads is formed copper and a second of said pads is formed of stainless steel.

21. A method of ionizing water via cavitation chemistry, said method comprising:
forcing a quantity of water, under pressure, through said water intake end of the device of claim 1, wherein said water is forced into said inner chamber of said third tube and into said inner chambers of said second and first tubes, respectively, via said plurality of holes of said third and second tubes, respectively, and exiting through said water outlet end of said first tube.

22. The method of claim 21, wherein said device further includes at least one porous metal pad disposed between said second end of said second tube and said water outlet end of said first tube, wherein as said water is forced through said plurality of holes of said third and second tubes, respectively, said water is further forced through said at least one first metal pad.

23. The method of claim 22, wherein said pad metal selected from copper, copper alloys, stainless steel, and nickel.

24. The device of claim 23, including at least two of said metal pads, wherein one of said pads is formed of copper and a second of said pads is formed of stainless steel.

25. A method of removing hydrocarbon contaminants from soil, said method comprising:
a. preparing a quantity of hydroxyl ion rich water by the method of claim 21;
b. applying said hydroxyl ion rich water to a quantity of soil containing hydrocarbon contaminants; and
c. applying an oxidizer selected from the group of hydrogen peroxide and potassium permanganate to said soil.

26. The method of claim 25, wherein said hydroxyl ion rich water and said oxidizer are applied to said soil simultaneously.

27. The method of claim 25, wherein said contaminants comprise petroleum.
